(19) United States
(12) Patent Application Publication
(10) Pub. No.: US 2005/0223400 A1
(43) Pub. Date: Oct. 6, 2005

(54) Spindle motor

(76) Inventors: Kunitake Matsushita, Shizuoka (JP); Takayuki Yamawaki, Shizuoka (JP); Katsutoshi Suzuki, Shizuoka (JP); Masaaki Inagaki, Shizuoka (JP)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/510,359

(22) PCT Filed: Apr. 4, 2003
(86) PCT No.: PCT/JP03/04349

§ 371 Date: Oct. 5, 2004

(30) Foreign Application Priority Data
Apr. 8, 2002 (JP) 2002-105136

(51) Int. Cl. G11B 17/028; G11B 17/03; G11B 19/20

(52) U.S. Cl. 720/702

(57) ABSTRACT

A spindle motor, in which the number of parts is kept from increasing and the number of assembling processes is reduced, and which has mechanisms for self-balancing and centrally aligning a disk, comprises a motor assembly (31) for rotating a disk (30) as a recording medium, a turntable (12) for mounting the disk (30), and a holder plate (14) disposed under the turntable (12). The mechanism for self-balancing is structured such that a plurality of steel balls (16) are disposed within an annular space (22) defined by the turntable (12) and the holder plate (14), and the mechanism for centrally aligning the disk (30) is constituted by a plurality of claw-shaped aligning members (5) formed at the inner circumference of the holder plate (14).

### FIELD OF THE INVENTION

The present invention relates to a spindle motor which is provided with mechanisms for self-balancing and centrally aligning a recording disk.

### BACKGROUND OF THE INVENTION

When a spindle motor is rotated at a high speed in an optical or any other type disk drive with a recording disk unbalancedly loaded, the disk drive vibrates, which may possibly trigger errors in recording in and reproducing from the disk, and which may lead to vibrating also peripheral equipments resulting in malfunction.

In order to deal with the problem of the disk drive vibrating due to the disk loaded with its gravity point positioned off a rotational axis, a spindle motor disclosed in Japanese Patent Application Laid-Open No. 2000-308306 is equipped with a self-balancing mechanism, which comprises an enclosed space having an annular ring shape, and balls adapted to freely move in the enclosed space, and which works such that the balls move automatically in the direction in which a vibrating disk drive moves thereby maintaining a balance.

Also, it may happen that a disk is not centrally aligned on a turntable due to the variation in its inner diameter dimension. In order to deal with this problem, as disclosed in Japanese Patent Applications Laid-Open Nos. 2000-251361 and 2000-331404, claw-like aligning members having elasticity are formed integrally with a plastic turntable fixed to a spindle motor, or with a portion of a center guide formed at the center of the turntable so that a disk is duly centered on the turntable irrespective of the variation in its inner diameter dimension, whereby the disk drive is kept free from vibration when the spindle motor rotates at a high speed.

Since the aforementioned aligning members must be durable, specifically abrasion-resistant to survive frequent loading and unloading of disks while the turntable including the center guide must be precisely dimensioned, it is difficult to satisfy the different requirements of the both components if they are formed using the same resin material. On the other hand, if the both components are formed using different resin materials, the numbers of materials, components, and also processes are increased thus pushing up production cost. For reduction in cost of the entire disk drive, the numbers of materials, components, and assembling processes must be kept from increasing, while the aligning members are formed to be durable, and the turntable is precisely dimensioned.

The present invention has been made in view of the above circumstances, and has for its object to provide a spindle motor which suppresses generation of vibration, and which holds down production cost while maintaining a good quality.

### SUMMARY OF THE INVENTION

In order to achieve the object, according to a fist aspect of the present invention, there is provided a spindle motor comprising: a turntable for receiving a recording disk; a holder plate disposed under the turntable; and a self-balancing mechanism including an enclosed space which is defined by the turntable and the holder plate, shaped like an annular ring, and which has a plurality of balls movably disposed thereinside, wherein the turntable has a plurality of openings pierced in its thickness direction and arrayed in its circumferential direction, and wherein the holder plate defines a circular opening at its center and has a plurality of claw-shaped aligning members which are punched out so as to remain in an area corresponding to the circular opening, bent up at an inner circumference of the circular opening perpendicularly to the holder plate so as to be inserted respectively through the openings of the turntable, and which have their tip portions protruding from a top face of the turntable, thereby allowing the disk mounted on the turntable to be a centrally aligned. With this structure, the bottom plate of the self-balancing mechanism, that is the holder plate, is formed integrally with the claw-shaped aligning members thereby decreasing the numbers of components and assembling processes as well, and at the same time the length of the claw-shaped aligning member is increased for the height of the self-balancing mechanism thereby making it easier to optimize the spring constant of the aligning member.

According to a second aspect of the present invention, in the spindle motor of the first aspect, the holder plate may be made of a steel plate, and each of the claw-shaped aligning members may be bent toward a center of the turntable at its tip portion. Consecuently, the claw-shaped aligning members improve readily in durability, and the disk is prevented from getting scratched when mounted on or dismounded from the turntable.

According to a third aspect of the present invention, in the spindle motor of the first aspect, the holder plate may be made of a steel plate, and each of the claw-shaped aligning members may be bent toward a center of the turntable at its tip portion, and further may be bent outward at a portion positioned below the bent tip portion so as to press the disk downward against the top face of the turntable. Consecuently, the disk is securely held onto the turntable.

According to a fourth aspect of the present invention, in the spindle motor of any one of the first to third aspects, each of the aligning members has, on a surface thereof in contact with a surface of an inner circumference of the disk which defines a circular center hole, a convex curve formed widthwise which has a curvature radius smaller than that of the circular center hole of the disk. Consecuently, the surface of the inner circumference of the disk is kept free from scratches due to loading and unloading.

According to a fifth aspect of the present invention, in the spindle motor of any one of the first to fourth aspects, the inner circumference of the holder plate may be engaged with the outer circumference of a partition formed on a face of the turntable opposite to the top face for receiving the disk. Consecuently, the aligning members are precisely positioned with respect to the center of the turntable thereby precisely getting the disk centered on the turntable.

Thus, the spindle motor according to the present invention includes a self-balancing mechanism, in which the holder plate made of steel and adapted to cover the bottom face of the turntable is provided with a plurality of claw-shaped aligning members which go through respective openings of the turntable so as to have their tip portions protrude from the top face of the turntable thereby providing a function to centrally align the disk. Consecuently, the disk can be duly centered on the turntable without increasing the numbers of components and also with reduced number of assembling processes.

Further, the claw-shaped aligning members of the holder plate are engaged with the circular positioning partition of the turntable, and therefore can be constantly positioned at a predetermined place. Also, the claw-shaped aligning members are allowed to be dimensioned larger than conventionally, and therefore can be sufficiently elastic.

Still further, since the claw-shaped aligning members are curved with a predetermined curvature, the disk can be loaded and unloaded easily, and at the same time can be free from scratches thereby securely fixing the disk and achieving a high endurance.

### BRIEF DESCRIPTION OF THE DRAWINGS

FIG. 1 is a partly sectioned side view of a spindle motor according to the present invention;

FIG. 2 is an exploded perspective view of a self-balancing mechanism provided for the spindle motor according to the present invention;

FIG. 3 is a perspective view of a holder plate provided for the spindle motor according to the present invention;

FIGS. 4A to 4C are respectively side, perspective and top views of one of aligning members (claws) of the holder plate shown in FIG. 3;

FIG. 5 is a partly sectioned side view of a turntable provided for the spindle motor according to the present invention; and

FIG. 6 is a bottom view of the turntable shown in FIG. 5.

### DETAILED DESCRIPTION OF THE PREFERRED EMBODIMENT

A preferred embodiment of the present invention will be described with reference to the accompanying drawings.

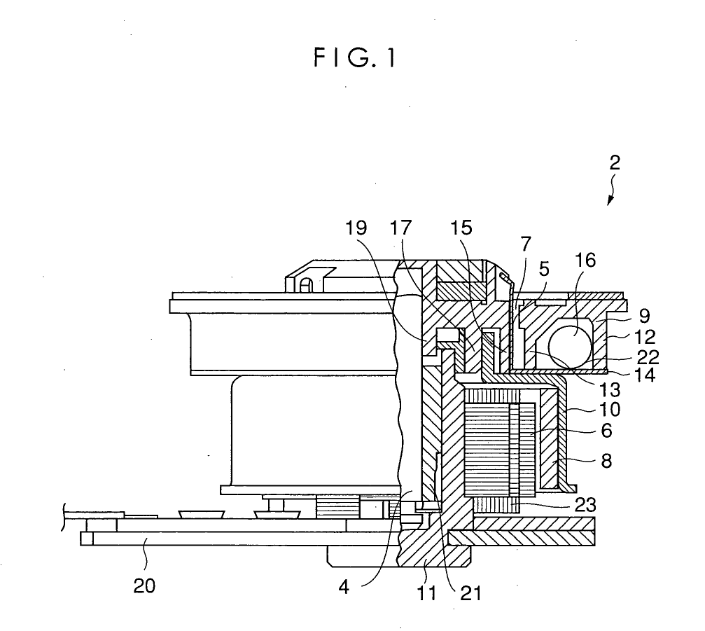

Referring to FIG. 1, a spindle motor 2 according to the embodiment of the present invention generally comprises a motor assembly 31 composed of a rotary shaft 4, a stator 6, a rotor magnet 8, a rotor yoke 10, and a housing 11, further comprises a turntable 12, and a holder plate 14, and is attached to a base plate 20.

The rotor magnet 8 is a hollow-cylindrical permanent magnet, and fixed to the inner circumference of the rotor yoke 10, which, together with the turntable 12, is fixedly attached to the rotary shaft 4.

The rotary shaft 4 is rotatably held by a bearing 21 disposed inside the housing 11 attached to the base plate 20.

The stator 6 has coils 23 wound therearound, is fixed to the housing 11, and faces the inner circumferential surface of the rotor magnet 8 with a slight air gap therebetween. The rotor yoke 10 is made of a steel plate by drawing process into a double-staged hollow-cylindrical structure basically consisting of two cylindrical portions which have respective different diameters, and which are concentric with each other, and the rotor magnet 8 is fixed to the inner surface of one cylindrical portion having a larger diameter.

The turntable 12 is made of resin, disposed over the rotor yoke 10, and has, on its bottom face (facing the rotor yoke 10), a plurality of circular partitions having respective different diameters and formed concentric with one another. In this embodiment, five partitions are provided as shown in FIG. 6: (from the outside to the center) a first partition 9; a second partition 13; a positioning partition 15 for holding a holder plate 14 in place; a yoke holding partition 17 for holding the other cylindrical portion of the rotor yoke 10 having a smaller diameter; and a shaft holding partition 19 fixedly in contact with the rotary shaft 4.

The first partition 9 and the second partition 13 form an enclosed space 22 having an annular ring shape and adapted to movably house a plurality of steel balls 16 when the holder plate 14 is attached to their bottom portions.

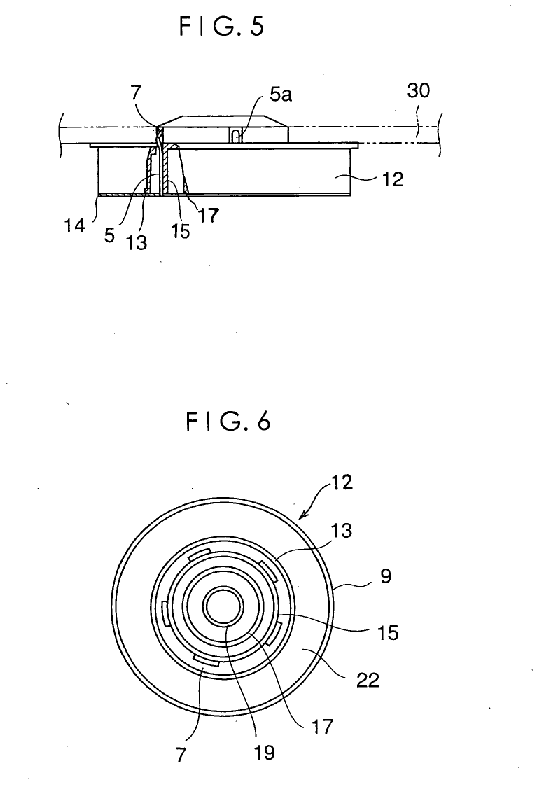

As shown in FIG. 5, the positioning partition 15 has an outer diameter substantially equal to the inner diameter of the holder plate 14 to be detailed later. A plurality (five in this embodiment) of slit-like openings 7 are arrayed circumferentially along the outer circumference of the positioning partition 15 at an equal interval so as to allow claw-shaped aligning members 5 (to be detailed later, hereinafter referred to simply as “claws” as appropriate) of the holder plate 14 to go therethrough and protrude beyond the top face of the turntable 12.

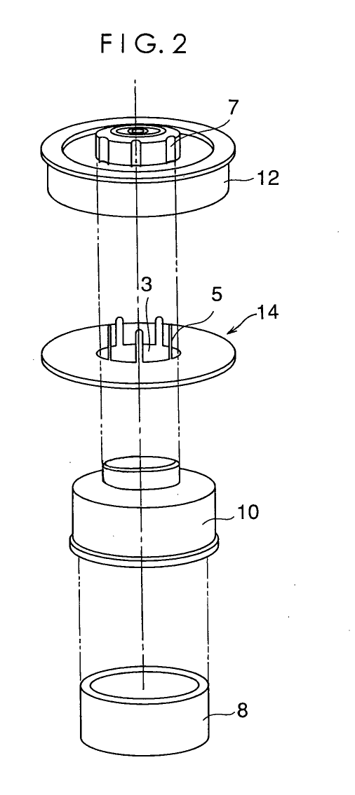

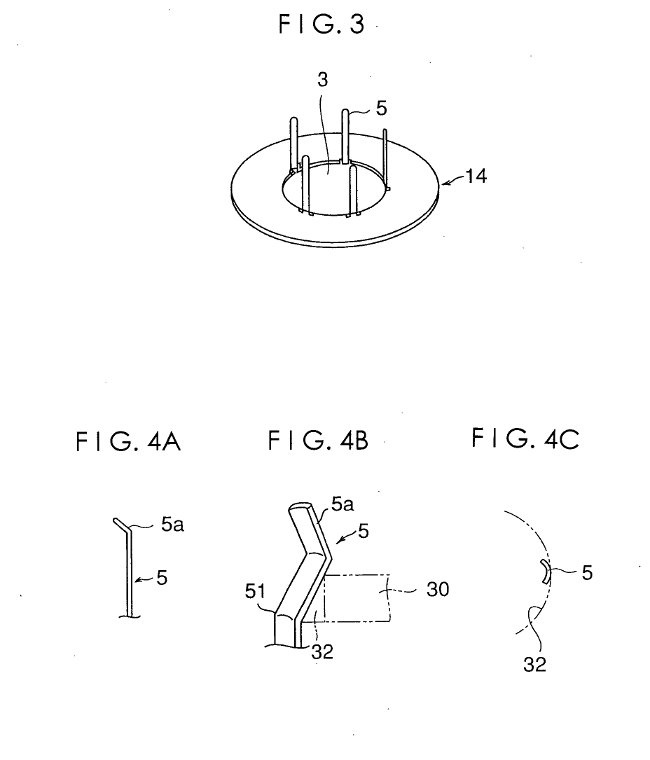

Referring to FIG. 3, the holder plate 14 is made of a stainless steel plate with a thickness of, for example, 3 mm by punching into a ring defining a center opening 3, such that a plurality (five in this embodiment) of aforementioned claws 5 are left equidistantly at the inner circumference of the ring so as to radially extend inward. The claws 5 thus shaped with, for example, a width of 1 mm and a length of 6.5 mm are then bent up at the inner circumference at an angle of 90 degrees with respect to the surface of the holder plate 14. Since the length of the claws 5 thus formed is larger than that of conventional claws by a dimension corresponding to the height of the turntable 12, the spring constant of the claws 5 can be easily optimized. In this connection, the claws 5 are formed at places corresponding to the openings 7 formed at the turntable 12.

When the center opening 3 of the holder plate 14 is engaged with the positioning partition 15 of the turntable 12, the claws 5 go through the respective openings 7 of the turntable 12 and have their tip portions 5a protrude beyond the top face of the turntable 12 as shown in FIG. 5, whereby a disk 30 loaded on the turntable 12 can be centrally aligned by means of the claws 5 protruding.

Referring to FIG. 4A, the claw 5 is bent toward the center of the turntable 12 at its tip portion 5a for easier loading of the disk 30. Referring then to FIG. 4B, the claw 5 is bent toward the center of the turntable 12 at its tip portion 5a, and further is bent outward at a portion 51 positioned below the bent tip portion 5a, whereby the disk 30 loaded on the turntable 12 is pressed downward against the top face of the turntable 12 thereby ensuring a secure hold of the disk 30 to the turntable 12 while achieving an appropriate elasticity and therefore a high durability as well. Referring further to FIG. 4C, the claw 5 is arced widthwise with a curvature radius smaller than that of a circular center hole 32 of the disk 30 so that the inner circumferential surface of the circular center hole 32 of the disk 30 is kept free from getting scratched even if the disk 30 is mounted on and dismounted from the turntable repeatedly. The aforementioned three examples shown in FIGS. 4A to 4C may be employed independently or in combination for preventing the disk 30 from getting scratched.

Reference is made now to FIG. 2 and also FIG. 5, the holder plate 14 is attached to the bottom face of the turntable 12 with the claws 5 engaging with the outer circumference of the positioning partition 15, and then the rotor yoke 10 is engaged with the yoke holding partition 17 of the turntable 12, whereby the holder plate 14, the turntable 12, and the rotor yoke 10 are integrally and securely fixed to one another thus ensuring the concentricity of the holder plate 14 with the turntable 12, which results in achieving a high precision of the relative positional relation between the claws 5 and the openings 7.

And, referring to FIGS. 1 and 6, the holder plate 14 functions as a lid to cover the bottom face of the turntable 12 thereby forming the enclosed space 22 shaped like an annular ring and adapted to movably house the plurality of steel balls 16 thus constituting a self-balancing mechanism. Needless to say, when the self-balancing mechanism is not required, this structure can be applied without the balls put in the enclosed space 22.

Thus, since the spindle motor 2 according to the present invention is provided with a disk aligning function in such a manner that the claws 5 of the holder plate 14 to cover the bottom of the turntable 12 are let through the openings 7 of the turntable 12, and have their tip portions 5a protrude from the top of the turntable 12 to thereby centrally align the disk 30, the number of components as a whole can be kept from increasing, and the number of assembling processes can be decreased.

1. A spindle motor comprising:
a turntable for receiving a recording disk;
a holder plate disposed under the turntable; and
a self-balancing mechanism including an enclosed space which is defined by the turntable and the holder plate, shaped like an annular ring, and which has a plurality of balls movably disposed thereinside,
wherein the turntable has a plurality of openings pierced in its thickness direction and arrayed in its circumferential direction, and
wherein the holder plate defines a circular opening at its center and has a plurality of claw-shaped aligning members which are punched out so as to remain in an area corresponding to the circular opening, bent up at an inner circumference of the circular opening perpendicularly to the holder plate so as to be inserted respectively through the openings of the turntable, and which have their tip portions protruding from a top face of the turntable, thereby allowing the disk mounted on the turntable to be centrally aligned.

2. A spindle motor according to claim 1, wherein the holder plate is made of a steel plate, and each of the aligning members is bent toward a center of the turntable at its tip portion.

3. A spindle motor according to claim 1, wherein the holder plate is made of a steel plate, and each of the aligning members is bent toward a center of the turntable at its tip portion, and further is bent outward at a portion positioned below the bent tip portion so as to press the disk downward against the top face of the turntable.

4. A spindle motor according to claim 1, wherein each of the aligning members has, on a surface thereof in contact with a surface of an inner circumference of the disk which defines a circular center hole, a convex curve formed widthwise which has a curvature radius smaller than that of the circular center hole of the disk.

5. A spindle motor according to claim 1, wherein the inner circumference of the holder plate is engaged with an outer circumference of a partition formed on a face of the turntable opposite to the top face for receiving the disk.
